(19) United States
(12) Patent Application Publication
(10) Pub. No.: US 2026/0358645 A1
(43) Pub. Date: Nov. 12, 2026

(54) MULTI-CHANNEL OPTICAL TRANSMISSION DEVICE

(71) Applicant: BROWAVE CORPORATION, HSINCHU COUNTY (TW)

(72) Inventors: Yu-Wen HWANG, HSINCHU COUNTY (TW); Feng-Chiang CHAO, TAICHUNG CITY (TW)

(21) Appl. No.: 19/204,931

(22) Filed: May 12, 2025

(51) Int. Cl. G02B 27/14; G02B 27/10

(52) U.S. Cl. CPC G02B 27/14; G02B 27/1006

(57) ABSTRACT

The present disclosure provides an optical device. The optical device includes a filter module, a lens array, a first focal length adjuster, and a receiver extension. The filter module is disposed on a predetermined optical path, and includes a plurality of first type filters corresponding respectively to a plurality of divided optical signals of different wavelengths. The lens array is disposed on the predetermined optical path. The first focal length adjuster is disposed on the predetermined optical path and attached to the lens array. The first focal length adjuster includes a plurality of sections. Respective focal lengths of the plurality of divided optical signals is adjusted by the plurality of sections. At least two of the plurality of sections have different refractive indexes. The receiver extension is configured to receive the plurality of divided optical signals adjusted by the first focal length adjuster.

### BACKGROUND

Fiber optic networks are becoming popular for data transmission. Multi-channel optical transmission device can be utilized to improve the capability of data transmission.

However, multi-channel optical transmission device often faces the issue of insertion loss, which is the loss of signal power resulting from the insertion of a device in optical fiber(s) or transmission line(s). Insertion loss is a key performance parameter for transmission applications, and is often measured in decibels (dB). Furthermore, calibration may be time-consuming since the divided optical signal carried by each channel possess different characteristics. Therefore, improved configuration for multi-channel optical transmission device is highly demanded.

### SUMMARY

It is one aspect of the present disclosure to provide an optical device. The optical device includes a filter module, a lens array, a first focal length adjuster, and a receiver extension. The filter module is disposed on a predetermined optical path, and includes a plurality of first type filters corresponding respectively to a plurality of divided optical signals of different wavelengths. The lens array is disposed on the predetermined optical path. The first focal length adjuster is disposed on the predetermined optical path and attached to the lens array. The first focal length adjuster includes a plurality of sections. Respective focal lengths of the plurality of divided optical signals is adjusted by the plurality of sections. At least two of the plurality of sections have different refractive indexes. The receiver extension is configured to receive the plurality of divided optical signals adjusted by the first focal length adjuster.

It is one aspect of the present disclosure to provide an optical device. The optical device includes a filter module, a lens array, a first focal length adjuster, and a receiver extension. The filter module is disposed on a predetermined optical path, and includes a plurality of first type filters corresponding respectively to a plurality of divided optical signals of different characteristics. The lens array is disposed on the predetermined optical path. The first focal length adjuster is disposed on the predetermined optical path and attached to the lens array. The first focal length adjuster includes a plurality of sections having different refractive indexes within a range from 1.3 to 3. The plurality of divided optical signals pass through the plurality of sections. The receiver extension is configured to receive the plurality of divided optical signals exiting the first focal length adjuster.

The optical devices mentioned above mitigate the overall insertion loss, simplify the assembly processes, and are well-suited for applications with limited encapsulation space.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a top view of an optical device according to some examples of the present disclosure.

FIG. 2 is a top view of an optical device according to some embodiments of the present disclosure.

FIG. 3A is a diagram showing comparison of insertion losses of channels between the optical devices of FIG. 1 and FIG. 2, according to some embodiments of the present disclosure.

FIG. 3B is a diagram showing the insertion losses of channels of an optical device, according to some embodiments of the present disclosure.

FIG. 4 is a top view of an optical device according to some embodiments of the present disclosure.

FIG. 5 is a side view of the optical device of FIG. 4 according to some embodiments of the present disclosure.

FIG. 6 is a perspective view showing an optical device of FIG. 4 according to some embodiments of the present disclosure.

FIG. 7 is a top view of an optical device according to some embodiments of the present disclosure.

FIG. 8 is a top view of an optical device according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper” and the like, may be used herein for ease of description to describe one element or feature's relationship to another element(s) or feature(s) as illustrated in the drawings. The spatially relative terms are intended to encompass different orientations of the device in use or operation in addition to the orientation depicted in the drawings. The apparatus may be otherwise oriented (e.g., rotated by 90 degrees or at other orientations) and the spatially relative descriptors used herein may likewise be interpreted accordingly. Further, it will be understood that when an element is referred to as being “connected to” or “coupled to” another element, it may be directly connected to or coupled to the other element, or intervening elements may be present.

A multiplexing (MUX) device is utilized to combine a number of optical signals of different wavelengths into an optical fiber (or other suitable transmission waveguide). The combined light exiting from an optical fiber (or other suitable transmission waveguide) can be decomposed into its components having different wavelengths using a demultiplexing (DEMUX) device. The MUX and DEMUX devices in some comparative embodiments (hereinafter “comparative MUX and DEMUX devices”) have multi-channel configurations, where the optical signals in the channels have different characteristics, such as wavelength and focal length. Since the comparative MUX and DEMUX devices lack the ability to unify the signal characteristics, significant insertion loss occurs when the optical signals propagate in the comparative MUX or DEMUX device.

The term “focal length adjuster” in the present disclosure may be referred to one or more optical elements that have the ability to adjust the focal length of a plurality of optical signal(s) (i.e., the beam(s)) and/or the position(s) of the focal point(s) of said plurality of optical signal(s) (i.e., the beam(s)). In some embodiments, the focal length adjuster can be composed of materials transparent or translucent to the optical beams and hence allowing optical beams to enter, propagate, and exit the body of the focal length adjuster. In some embodiments, the focal length adjuster can be a prism, a lens array, or combinations thereof.

The term “focal point” in the present disclosure may include embodiments wherein “focal point” is referred to a point where a beam converges at, and embodiments wherein “focal point” is referred to a specific area on a focal plane (a plane with minimal beam diameter) where a beam converges at.

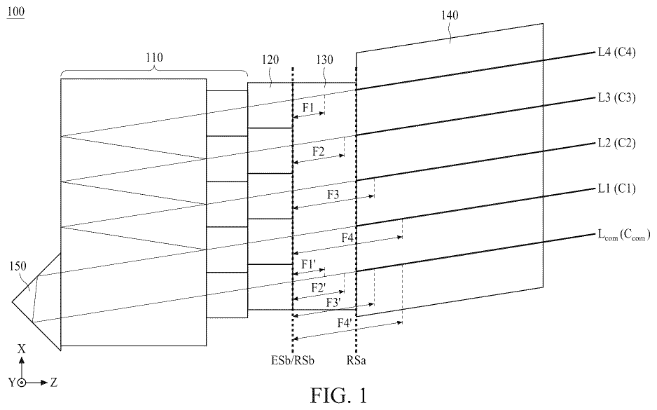

FIG. 1 is a top view of an optical device 100 according to some examples of the present disclosure. The optical device 100 includes a filter module 110, a lens array 120, a spacer 130, a receiver extension 140, and a prism 150. The lens array 120 is attached by its two opposite sides to the filter module 110 and the spacer 130. The spacer 130 is attached by its two opposite sides to the receiver extension 140 and the lens array 120. The prism 150 is attached to a side of the filter module 110 distant from the lens array 120. Therefore, there is no free space between the adjacent components of the optical device 100.

The receiver extension 140 includes a common channel C_{com} and divided channels C1 to C4. The spacer 130 includes materials transparent to the optical signals (i.e., the beam(s)) from the common channel C_{com} and the divided channels C1 to C4, for example, glass. The receiver extension 140 may include photodiodes, grating couplers, edge couplers, an optical fiber array, an optical absorber array, other suitable optical receiving elements, or the combination thereof. In some embodiments, the optical device 100 is configured to divide or demultiplex (DEMUX) a combined optical signal L_{com} (e.g., a combined beam) of the common channel C_{com} to output divided optical signals L1 to L4 (e.g., divided beams) of the divided channels C1 to C4. In other embodiments, the optical device 100 is configured to merge or multiplex (MUX) the divided optical signals L1 o L4 of the divided channels C1 to C4 to output the combined optical signal L_{com} of the common channel C_{com}. In other words, the optical device 100 can be a MUX device or a DEMUX device.

The divided optical signals L1 to L4 have different characteristics, such as different wavelengths and working distances. The term “working distance” in the present disclosure may be referred to the physical distance from the exiting surface ESb of the lens array 120 to a receiving surface of an optical component (e.g., an optical fiber array) where the beam is coupled with minimum insertion loss (i.e., having the best coupling efficiency). When the beam is well collimated, the working distance may be close to or same as the focal length of the beam. When the optical device 100 is configured as a DEMUX device, the distal end(s) of the focal lengths F1 to F4 (i.e., the focal point(s)) of one or more of the divided optical signals L1 to L4 may be too far away from the receiving surface RSa of the receiver extension 140. When the optical device 100 is configured as a MUX device, the divided optical signals L1 to L4 do not merge within a thin band as the focal lengths F1′ to F4′ of the divided optical signals L1 to L4 are vastly different from each other. Therefore, significant insertion loss may be incurred and the performance of the optical device 100 may not be desired.

In some comparative embodiments, orientations of prisms or prisms with varying curvatures are used to adjust focal lengths of optical signals from different channels, thereby mitigating insertion loss. However, the design complexity and overall volume of these approaches rises significantly as the number of the channels grows.

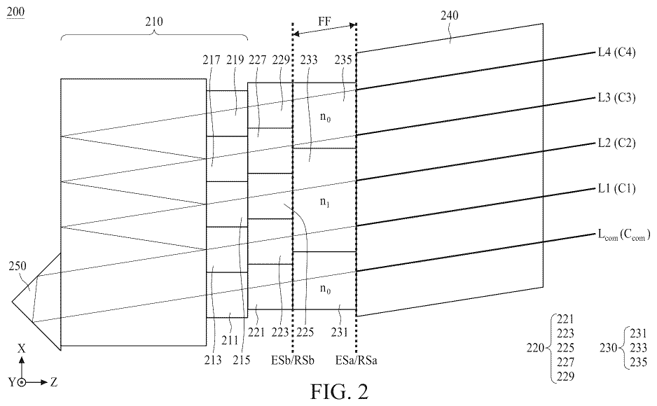

FIG. 2 is a top view of an optical device 200 according to some embodiments of the present disclosure. The optical device 200 includes a filter module 210, a lens array 220, a focal length adjuster 230, a receiver extension 240, and a prism 250, which are all disposed on a predetermined optical path. The lens array 220 has a first side attached to the filter module 210, and has a second side attached to a receiving surface RSb of the focal length adjuster 230. The first side and second side of the lens array 220 are opposite to each other. The focal length adjuster 230 includes an exiting surface ESa opposite to the receiving surface RSb, while the exiting surface ESa is attached to the receiving surface RSa of the receiver extension 240. The prism 250 is attached to a side of the filter module 210 distant from the lens array 220. Therefore, there is no free space between the adjacent components of the optical device 200.

The focal length adjuster 230 includes multiple sections 231, 233, and 235, while at least two of the sections 231 to 235 have different refractive indexes. For example, the sections 231 to 235 have refractive indexes n0, n1, and n0, respectively. The section 231 corresponds to the combined optical signal L_{com}; the section 233 corresponds to the divided optical signals L1 and L2; and the section 235 corresponds to the divided optical signals L3 and L4. In other words, the combined optical signal L_{com} and the divided optical signals L1 to L4 pass through the sections 231 to 235, and their focal lengths are adaptively altered by the sections 231 to 235 with different refractive indexes. However, the number of the sections are provided for illustrative purposes only, and the present disclosure is not limited thereto. For example, the focal length adjuster 230 may include more or less sections provided that there are sections have different refractive indexes.

In some embodiments, the refractive index of each of the sections 231 to 235 is within a range from 1.3 to 3. The sections 231 to 235 may be made by SiO2, BK7 glass, BF33 glass, other suitable materials transparent to the combined optical signal L_{com} and the divided optical signals L1 to L4, or the combination thereof. In some embodiments, the focal length adjuster 230 is made by the following steps. First, multiple glass strips having the same thickness are bonded to a glass wafer with glue. Next, the glass strips and the glass wafer are cut into desired shapes. The cut glass strips form the sections 231 to 235 of the focal length adjuster 230, respectively, while the cut glass wafer forms the lens array 220. Therefore, the sections 231 to 235 have the same thickness, where the thickness of the sections 231 to 235 are measured along the Z-direction perpendicular to the receiving surface RSa of the receiver extension 240 or the exiting surface ESa of the focal length adjuster 230. The receiving surface RSb and the exiting surface ESa formed by the sections 231 to 235 are flat surfaces, and are parallel to each other.

The filter module 210 (which can also be referred to as Z-block or thin film filter block) includes multiple filters 211, 213, 215, 217, and 219. The filters 213 to 219 belong to a first type that each has a pass band corresponding to one of the divided optical signals L1 to L4. The pass bands of the filters 213 to 219 are different from each other. For example, the filter 213 allows the divided optical signal L1 to pass but blocks the divided optical signals L2 to L4; the filter 215 allows the divided optical signal L2 to pass but blocks the divided optical signals L1, L3, and L4, and so on. The filter 211 belongs to a second type that has a pass band covering all of the pass bands of the filters 213 to 219. Similar to the optical device 100 of FIG. 1, the optical device 200 of FIG. 2 can be a MUX device or a DEMUX device. The filter module 210 may demultiplex the combined optical signal L_{com} into the divided optical signals L1 to L4, and may multiplex the divided optical signals L1 to L4 into the combined optical signal L_{com}.

The lens array 220 includes multiple lenses 221, 223, 225, 227, and 229. The lenses 221 to 229 are aligned to the filters 211 to 219, respectively. When the optical device 200 is configured as a DEMUX device, the lens 221 is configured to collimate the combined optical signal L_{com} with the filter 211. When the optical device 200 is configured as a MUX device, the lenses 223 to 229 are configured to collimate the divided optical signals L1 to L4 respectively with the filters 213 to 219.

The prism 250 is optically aligned with the common channel C_{com} and the divided channel C1. In some embodiments, the prism 250 is a right angle prism, and is configured to guide the combined optical signal L_{com} from the filter 211 to the filter 213, or to guide the divided signals L1 to L4 from the filter 213 to the filter 211.

When the optical device 200 is configured as a DEMUX device, the receiver extension 240 is configured to receive the divided optical signals L1 to L4 adjusted by the focal length adjuster 230. The divided optical signals L1 to L4 from the sections 233 and 235 to the receiver extension 240 may have the focal lengths that are similar to the length FF. The length FF is measured from the exiting surface ESb of the lens array 220 to the receiving surface RSa of the receiver extension 240, along the propagation direction of one of the optical signals L1 to L4 in the focal length adjuster 230. Therefore, the focal points of the divided optical signals L1 to L4 are located substantially on the receiving surface RSa of the receiver extension 240. Furthermore, when the optical device 200 is configured as a MUX device, the receiver extension 240 is configured to receive the multiplexed optical signal L_{com}. The divided optical signals L1 to L4 from the sections 233 and 235 to the section 231 may have the focal lengths that are similar to the length FF. Therefore, the divided optical signals L1 to L4 can be effectively combined into the combined optical signal L_{com}. Accordingly, the optical device 200 has improved insertion loss and a better device performance.

In some embodiments, the focal points of the optical signals L1 to L4 are spaced apart from the receiving surface RSa of the receiver extension 140 by no more than a tolerable distance z. In other words, the focal points of the optical signals L1 to L4 are located in a tolerable range from (RSa−z) to (RSa+z). The tolerable distance z can be derived from the following formula (1):

W(z)=Wo[1+(z/Zr)²]^{1/2}−1 (1)

With respect to the formula (1), z is a distance from a focal point of a beam; W(z) is a radius of the beam at the plane apart from a focal point of a beam by the distance z (which can be associated with or derived from a size or a diameter of the effective sensing area of the receiver extension 140, such as the diameter of the photodiode); Wo is a radius of beam size at the focal plane, Zr is the Rayleigh distance of the beam. The Rayleigh distance is related to a wavelength of a certain optical beam. For example, in an application of single mode fiber transmitting an optical beam having 1310 nm wavelength, the Rayleigh distance would be around 50 μm in the air.

In a first embodiment, for the optical signals passing through the same section, an average value of the wavelengths thereof is used in the formula (1) to determine the tolerable distance z. Then, the refractive index of the section may be determined according to the tolerable distance z, making the focal points of the optical signals locate in the tolerable range. For example, the refractive index n1 of the section 233 of FIG. 2 may be determined according to an average value of the wavelengths of the optical signals L1 and L2. As a result, the focal points of the optical signals L1 and L2 locate in the tolerable range.

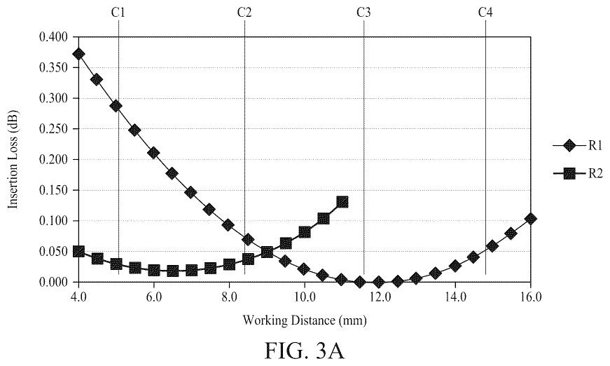

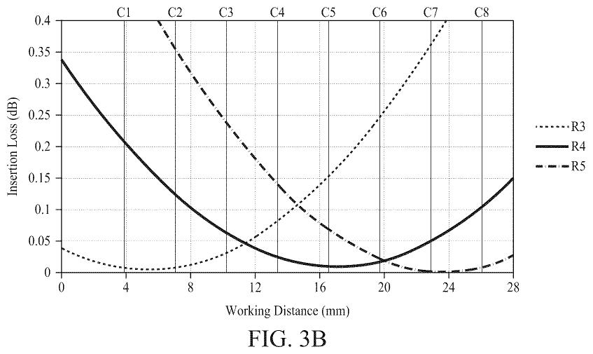

In second embodiment, the middle one of the wavelengths (hereinafter “the middle wavelength”) of the optical signals passing through the same section is used in the formula (1) to determine the tolerable distance z. Then, the refractive index of the section may be determined according to the tolerable distance z. The focal point of the optical signal having the middle wavelength is altered by the section to being located on the receiving surface RSa of the receiver extension 140, while the focal points of the other optical signals is altered by the section to being located in the tolerable range. For example, referring to FIG. 3B, the wavelength of the optical signal of the channel C2 is the middle one of the wavelengths of the optical signals of the channels C1 to C3, while the optical signals of the channels C1 to C3 pass through the same section of the spacer. The refractive index of the section corresponding to the channels C1 to C3 may be determined by the wavelength of the optical signal of the channel C2. As a result, the focal point of the optical signal of the channel C2 locates on the receiving surface RSa of the receiver extension 140, while the focal points of the optical signals of the channels C1 and C3 locate in the tolerable range. It is noted that the refraction indexes of two (2) different sections may be determined according to the abovementioned first and second embodiments, respectively.

In addition, since all of the sections have the same width that may also affect the focal lengths of the optical signals, the one or more wavelengths used to determine the tolerable distance z may also be used to determine the width of all of the sections.

FIG. 3A is a diagram showing comparison of insertion loss of channels between the optical device 100 of FIG. 1 and the optical device 200 of FIG. 2, according to some embodiments of the present disclosure. The comparison is conducted under the situation that both the optical devices 100 and 200 are configured as the DEMUX devices. Referring to FIG. 1 and FIG. 3A, the curve R1 shows the insertion loss of the divided channels C1 to C4 of the optical device 100 of FIG. 1, where the divided optical signals L1 to L4 from the divided channels C1 to C4 all pass through the spacer 130. Since the spacer 130 has a uniform refractive index and lacks of the ability of adaptively altering the focal lengths, it can be observed that the divided channel C4 of FIG. 1 has a high insertion loss.

Referring to FIG. 2 and FIG. 3A, the curve R2 shows the insertion loss of the divided channels C3 and C4 of the optical device 200 of FIG. 2. According to the right half portion of the curve R1 and the curve R2, it can be observed that the divided channels C1 to C4 of FIG. 2 have desired insertion losses, all of which are lower than 0.05 dBs. The reason is that the optical device 200 provides the section 233 with a higher refractive index n1 for the divided optical signals L1 and L2, which have shorter working distances, while providing the section 235 with the lower refractive index n0 for the divided optical signals L3 and L4, which have longer working distances. That is, the refractive index n1 is greater than the refractive index n0 (n1>n0). Accordingly, for mitigating the insertion loss, the refractive index of each section of FIG. 2 is negatively correlated to the working distance of the divided optical signal(s) passing through such section.

FIG. 3B is a diagram showing the insertion loss of channels of an optical devices including more channels than the optical device of FIG. 2, according to some embodiments of the present disclosure. The optical device described with reference to FIG. 3 includes eight (8) channels C1 to C8. The optical signals from the channels C1 to C8 have working distances sequentially increasing. A curve R3 shows the insertion losses of applying a spacer with a uniform refractive index (e.g., 1.504) to all of the channels C1 to C8. It is noted that the channels C4 to C8 suffer from insertion losses higher than 0.05 dBs, which degrades the performance of the optical device. Similarly, curves R4 and R5 show the insertion losses of applying the respective spacers with the uniform refractive indexes (e.g., 1.476 and 1.459) to all of the channels C1 to C8.

In some embodiments, the optical device described with reference to FIG. 3 includes a spacer having three (3) sections of different refractive indexes. The section corresponds to the channels C1 to C3 has the highest refractive index (e.g., 1.504). The section corresponds to the channels C4 to C6 has a medium refractive index (e.g., 1.476). The section corresponds to the channels C7 and C8 has the lowest refractive index (e.g., 1.459). Under this situation, the insertion losses of the channels C1 to C3 are represented by the curve R3; the insertion losses of the channels C4 to C6 are represented by the curve R4; and the insertion losses of the channels C7 and C8 are represented by the curve R5. It is noted that all of the channels C1 to C8 have desired insertion losses, which are lower than 0.05 dBs.

Accordingly, when the number of the channels increases, the number of the sections in the focal length adjuster can be easily modified to a corresponding number (for example, by using the glass strips of the corresponding number) to maintain the insertion losses below a desired threshold value. Therefore, the design complexity is reduced. In addition, the focal length adjuster is compact and well-suitable for applications with limited encapsulation space.

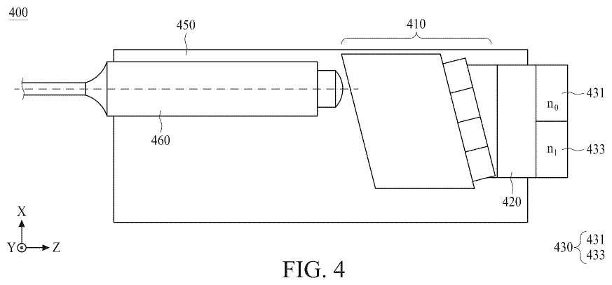

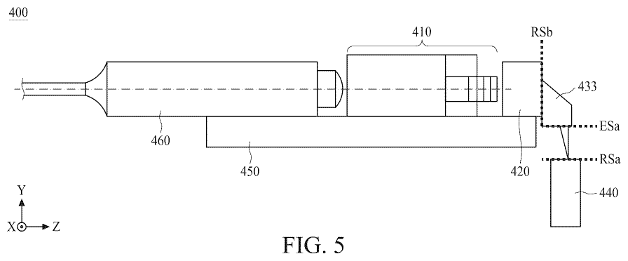

FIG. 4 is a top view of an optical device 400 according to some embodiments of the present disclosure. FIG. 5 is a side view of the optical device 400 of FIG. 4 according to some embodiments of the present disclosure. The optical device 400 includes a filter module 410 (which can also be referred to as Z-block or thin film filter block), a carrier 450, and a collimator 460. The filter module 410 and the collimator 460 are disposed on the carrier 450 and on a predetermined optical path. The optical device 400 further includes a lens array 420 and a focal length adjuster 430, which are disposed on the pre-determined optical path and on a side of the filter module 410 distant from the collimator 460. The focal length adjuster 430 is attached to a side of the lens array 420 distant from the filter module 410. The filter module 410 and the lens array 420 are respectively similar to the filter module 210 and the lens array 220 of FIG. 2; therefore, the detailed descriptions thereof are omitted. The optical device 400 further includes a receiver extension 440 configured to receive the divided optical signals L1 to L4 adjusted by the focal length adjuster 430. There may be free spaces between the components of the optical device 400. For example, there are free spaces between the collimator 460 and the filter module 410, between the filter module 410 and the lens array 420, and between the focal length adjuster 430 and the receiver extension 440.

In some embodiments, the focal length adjuster 430 includes multiple sections 431 and 433, which have different refractive indexes n1 and n0. The focal length adjuster 430 alters the direction of received light or optical signals, for example, from a direction substantially parallel to X-Z plane to a direction unparalleled to X-Z plane. The focal length adjuster 430 includes a receiving surface RSb and an exiting surface ESa, where the receiving surface RSb is attached to the lens array 420. The receiving surface RSb and the exiting surface are not parallel to each other. In some embodiments, each section of the focal length adjuster 430 includes a prism, such as a right-angle prism, which has a surface substantially orthogonal to another surface. For example, the receiving surface RSb is substantially parallel to X-Y plane, while the exiting surface ESa is substantially parallel to the X-Z plane. In other words, the receiving surface RSb is arranged to face the lens array 420, while the exiting surface is arranged to face the receiver extension 440.

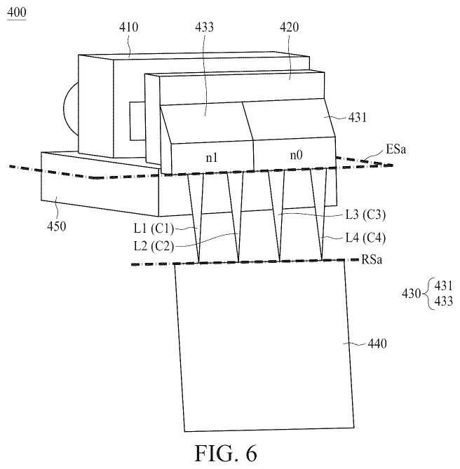

FIG. 6 is a perspective view showing an optical device of FIG. 4, according to some embodiments of the present disclosure. Referring to FIG. 4 and FIG. 6, when the optical device 400 is configured as a DEMUX device, the optical device 400 is configured to demultiplex the combined optical signal (not shown in FIG. 6) from the collimator 460 into divided optical signals L1 to L4. When the optical device 400 is configured as a MUX device, the optical device 400 is configured to multiplex the divided optical signals L1 to L4 from the receiver extension 440 into the combined optical signal that is transmitted into the collimator 460.

The focal length adjuster 430 includes multiple sections 431 and 433, which have different refractive indexes n1 and n0. The section 431 corresponds to the divided optical signals L1 and L2 having shorter working distances; therefore the section 431 has the greater refractive index n1. The section 433 corresponds to the divided signals L3 and L4 having longer working distances; therefore the section 433 has the smaller refractive index n0. As a result, the focal lengths of the divided optical signals L1 to L4 are adaptively altered by the sections 431 and 433, so that the focal point of the divided optical signals L1 to L4 are located substantially on a receiving surface RSa of the receiver extension 440. The receiver extension 440 includes divided channels C1 to C4, which are corresponding to the divided optical signals L1 to L4, respectively.

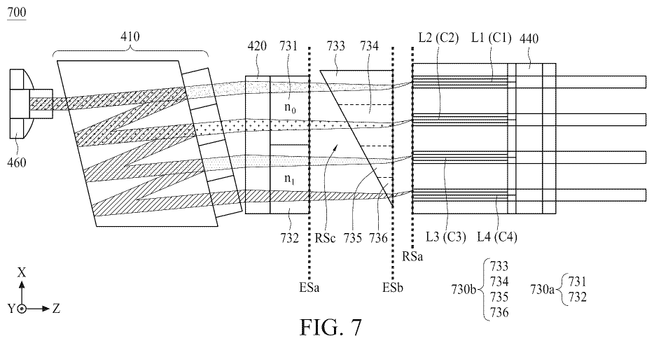

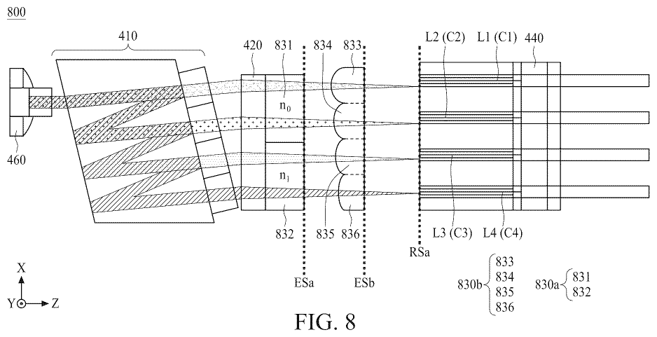

FIG. 7 and FIG. 8 are top views of optical devices 700 and 800 according to some embodiments of the present disclosure. The optical devices 700 and 800 are similar to the optical device 400 as discussed in FIG. 4 to FIG. 6, however, the main differences reside in that each of the optical device 800 includes multiple focal length adjusters sequentially disposed between the lens array 420 and the receiver extension 440. The first focal length adjuster (e.g., the focal length adjuster 730a in FIG. 7 and the focal length adjuster 830a in FIG. 8) is attached to the lens array 420. In some embodiments, the first focal length adjuster needs not to alter the direction of received light or optical signals, and can be made from glass strips as discussed in FIG. 2. In some embodiments, the first focal length adjuster alters the direction of received light or optical signals, and includes prisms as discussed in FIG. 6. The second focal length adjuster (e.g., the focal length adjuster 730b in FIG. 7 and the focal length adjuster 830b in FIG. 8) is free from attached to the lens array 420. The second focal length adjuster has a multiple sections. Each of the plurality of sections allows a beam to pass through and provides different amount of focal length adjustment to respective beams. That is, an extent of focal point adjustment is different in each section. In some embodiments, the second focal length adjuster includes a prism, a lens array, or a combination thereof.

With respect to FIG. 7, the focal length adjusters 730a, which is attached to the lens array, includes multiple sections 731 and 732 that have different refractive indexes n0 and n1. The focal length adjuster 730b is configured to assist the focal length adjuster 730a in altering the focal length of the optical signals L1 to L4, so as to improve the flexibility when designing the refractive indexes of the focal length adjusters 730a. The focal length adjuster 730b includes a prism, which includes multiple sections 733, 734, 735, and 736. In some embodiments, the sections 733 to 736 may have the same refractive index. In some embodiments, the sections 733 to 736 may have different widths, which are measured substantially along the propagation directions of the divided optical signals L1 to L4 (i.e., the Z-direction or the predetermined optical path). The focal length adjusters 730b includes a receiving surface RSc and an exiting surface ESb, which are both flat surfaces in some embodiments. The receiving surface RSc faces the focal length adjuster 730a, and is free from being parallel to the exiting surface ESa of the focal length adjuster 730a. The exiting surface ESb is parallel to the receiving surface RSa of the receiver extension 440.

In some embodiments, the focal length adjuster 730b has a triangular shape when viewing from the Y-direction; however, the present disclosure is not limited thereto. In some embodiments, the focal length adjuster 730b has a trapezoid shape or a staircase shape, provided that the sections of the focal length adjuster 730b have different widths along the Z-direction.

With respect to FIG. 8, the focal length adjusters 830a, which is attached to the lens array, includes multiple sections 831 and 832 that have different refractive indexes n0 and n1. The focal length adjuster 830b includes a lens array, which includes multiple sections (i.e., lens) 833, 834, 835, and 836. In some embodiments, the sections 833 to 836 may have the same refractive index. The sections 833 to 836 each has a curved surface facing the receiving surface ESa of the focal length adjuster 830a, where the radius of curvature of each of the sections 833 to 836 may be identical or different. The focal length adjuster 830b includes an exiting surface ESb facing the receiving surface RSa of the receiver extension 440. In some embodiments, the exiting surface ESb is a flat surface; however, the present disclosure is not limited thereto. In some embodiments, the each of the sections 833 to 836 has another curved surface, which faces the receiving surface RSa of the receiver extension 440.

Although each section in FIG. 7 and FIG. 8 corresponds to an optical signal, one or more sections may be omitted in some embodiments, provided that the focal length of at least one of the divided optical signals L1 to L4 is adjusted by the focal length adjuster 730b or 830b. For example, the section 736 in FIG. 7 can be omitted so that only the divided optical signals L1 to L3 pass through the focal length adjuster 730b, while the focal length of the divided optical signal L4 is not altered by the focal length adjuster 730b.

It should be noted that the approaches discussed above can be applied to various types of multi-channel configuration, including channels aligned along one row (1×N) and channels aligned along multiple rows (n×N), where n and N are positive integers. Regarding the comparative optical devices, a trade-off in insertion loss among optical signals from different channels may be made, which may result in reduced device performance. In addition, when assembling the comparative optical devices, it is time-consuming to arrange the element orientations and the distances between elements for obtaining an overall acceptable insertion loss. In comparison, the present disclosure provides optical devices that mitigate the overall insertion loss and can be used as a MUX device or a DEMUX device. Moreover, the optical devices of the present disclosure simplify the assembly processes.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical device, comprising:
a filter module, disposed on a predetermined optical path, comprising a plurality of first type filters corresponding respectively to a plurality of divided optical signals of different wavelengths;
a lens array, disposed on the predetermined optical path;
a first focal length adjuster, disposed on the predetermined optical path and attached to the lens array, comprising a plurality of sections, wherein respective focal lengths of the plurality of divided optical signals is adjusted by the plurality of sections, and at least two of the plurality of sections have different refractive indexes; and
a receiver extension, configured to receive the plurality of divided optical signals adjusted by the first focal length adjuster.

2. The optical device of claim 1, wherein a first section of the plurality of sections corresponds to a first divided optical signal of the plurality of divided optical signals, and a second section of the plurality of sections corresponds to a second divided optical signal of the plurality of divided optical signals,
wherein a working distance of the first divided optical signal is shorter than a working distance of the second divided optical signal, and a refractive index of the first section is greater than a refractive index of the second section.

3. The optical device of claim 1, wherein thicknesses of the plurality of sections are identical, and wherein the thicknesses of the plurality of sections are measured along a direction perpendicular to an exiting surface of the first focal length adjuster.

4. The optical device of claim 1, wherein the lens array has a first side attached to the filter module, and the first focal length adjuster has a first side attached to a second side of the lens array, and wherein the first side and the second side of the lens array are opposite to each other.

5. The optical device of claim 4, wherein the filter module is configured to multiplex the plurality of divided optical signals to output a combined optical signal or to demultiplex the combined optical signal to output the plurality of divided optical signals, and wherein a focal length of the combined optical signal is adjusted by a corresponding one of the plurality of sections.

6. The optical device of claim 5, wherein a first section and a second section of the plurality of sections of the first focal length adjuster have an identical refractive index, and wherein the first section corresponds to the combined optical signal and the second section corresponds to at least one of the plurality of divided optical signals.

7. The optical device of claim 1, wherein the first focal length adjuster comprises a receiving surface and an exiting surface, the receiving surface is arranged to face the lens array, and the exiting surface is arranged to face the receiver extension,
wherein the receiving surface is free from being parallel to the exiting surface.

8. The optical device of claim 1, further comprising a collimator disposed on the predetermined optical path and facing the filter module.

9. The optical device of claim 1, further comprising a second focal length adjuster, disposed on the predetermined optical path and between the first focal length adjuster and the receiver extension,
wherein the focal length of at least one of the plurality of divided optical signals is adjusted by the second focal length adjuster.

10. The optical device of claim 1, wherein a refractive index of one of the plurality of sections of the first focal length adjuster is determined according to an average value of wavelengths of corresponding optical signals passing through the one of the plurality of sections, or according to a middle one of wavelengths of the corresponding optical signals passing through the one of the plurality of sections.

11. An optical device, comprising:
a filter module, disposed on a predetermined optical path, comprising a plurality of first type filters corresponding respectively to a plurality of divided optical signals of different characteristics;
a lens array, disposed on the predetermined optical path;
a first focal length adjuster, disposed on the predetermined optical path and attached to the lens array, comprising a plurality of sections having different refractive indexes within a range from 1.3 to 3, wherein the plurality of divided optical signals pass through the plurality of sections; and
a receiver extension, configured to receive the plurality of divided optical signals exiting the first focal length adjuster.

12. The optical device of claim 11, wherein a refractive index of each section is negatively correlated to a working distance of one of the plurality of divided optical signals passing through the section.

13. The optical device of claim 11, wherein the first focal length adjuster comprises a receiving surface and an exiting surface, the receiving surface is arranged to face the lens array, and the exiting surface is arranged to face the receiver extension,
wherein the receiving surface and the exiting surface are flat surfaces parallel to each other.

14. The optical device of claim 13, wherein the lens array has a first side attached to the filter module, and the receiving surface is attached to a second side of the lens array, and wherein the first side and the second side of the lens array are opposite to each other.

15. The optical device of claim 14, wherein the filter module is configured to multiplex the plurality of divided optical signals to output a combined optical signal or to demultiplex the combined optical signal to output the plurality of divided optical signals, and wherein a focal length of the combined optical signal is adjusted by a corresponding one of the plurality of sections.

16. The optical device of claim 13, wherein the receiving surface is perpendicular to the exiting surface.

17. The optical device of claim 11, further comprising a second focal length adjuster, disposed on the predetermined optical path and between the first focal length adjuster and the receiver extension,
wherein at least one of the plurality of divided optical signals pass through the second focal length adjuster.

18. The optical device of claim 17, wherein the second focal length adjuster comprises a prism, and wherein a plurality of sections of the prism have different widths measured substantially along the propagation direction of the predetermined optical path.

19. The optical device of claim 17, wherein the second focal length adjuster comprises a lens array, and wherein each of a plurality of sections of the lens array has a curved surface facing the first focal length adjuster.

20. The optical device of claim 11, wherein a refractive index of one of the plurality of sections of the first focal length adjuster is determined according to an average value of wavelengths of corresponding optical signals passing through the one of the plurality of sections, or according to a middle one of wavelengths of the corresponding optical signals passing through the one of the plurality of sections.
